(19) United States
(12) Patent Application Publication
(10) Pub. No.: US 2016/0261544 A1
(43) Pub. Date: Sep. 8, 2016

(54) INCREASING INTERACTION BETWEEN CLUSTERS WITH LOW CONNECTIVITY IN A SOCIAL NETWORK

(71) Applicant: Linkedln Corporation, Mountain View, CA (US)

(72) Inventor: Michael Conover, San Francisco, CA (US)

(73) Assignee: Linkedln Corporation, Mountain View, CA (US)

(21) Appl. No.: 14/635,759

(22) Filed: Mar. 2, 2015

(51) Int. Cl. H04L 12/58; H04L 29/08

(52) U.S. Cl. CPC H04L 51/32; H04L 67/306

(57) ABSTRACT

The disclosed embodiments provide a system for facilitating interaction within a social network. During operation, the system obtains a set of clusters of users in a graph of a social network, wherein the graph includes a set of nodes representing the users and a set of edges representing relationships between pairs of the users. Next, the system identifies low connectivity between a first cluster and second cluster in the set of clusters and high compatibility between a first user from the first cluster and a second user from the second cluster. The system then generates, based on the high compatibility, an introduction of the first and second users to facilitate increased interaction between the first and second users.

### BACKGROUND

1. Field

The disclosed embodiments relate to social networks. More specifically, the disclosed embodiments relate to techniques for increasing interaction between clusters with low connectivity in social networks.

2. Related Art

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate business activities such as sales, marketing, and/or recruiting by the individuals and/or organizations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions.

However, people in social networks tend to be clustered into disparate, non-overlapping communities. For example, employees of a company may generally interact within the same functional units or organizations and thus lack exposure to the knowledge or perspective that other functional units or organizations in the company may have. Because information exchange between relatively unconnected communities in a social network is limited, the social capital within the social network may not be fully utilized.

Consequently, use of social networks may be facilitated by mechanisms for increasing interaction among communities with low connectivity in the social networks.

### BRIEF DESCRIPTION OF THE FIGURES

FIG. 1 shows a schematic of a system in accordance with the disclosed embodiments.

FIG. 2 shows a system for facilitating interaction within a social network in accordance with the disclosed embodiments.

FIG. 3 shows the exemplary identification of a high compatibility between a pair of users from a pair of clusters with low connectivity in a social network in accordance with the disclosed embodiments.

FIG. 4 shows a flowchart illustrating the process of facilitating interaction within a social network in accordance with the disclosed embodiments.

FIG. 5 shows a flowchart illustrating the process of identifying low connectivity between a first cluster and a second cluster in a social network in accordance with the disclosed embodiments.

FIG. 6 shows a flowchart illustrating the process of identifying high compatibility between a pair of users in a pair of clusters with low connectivity in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

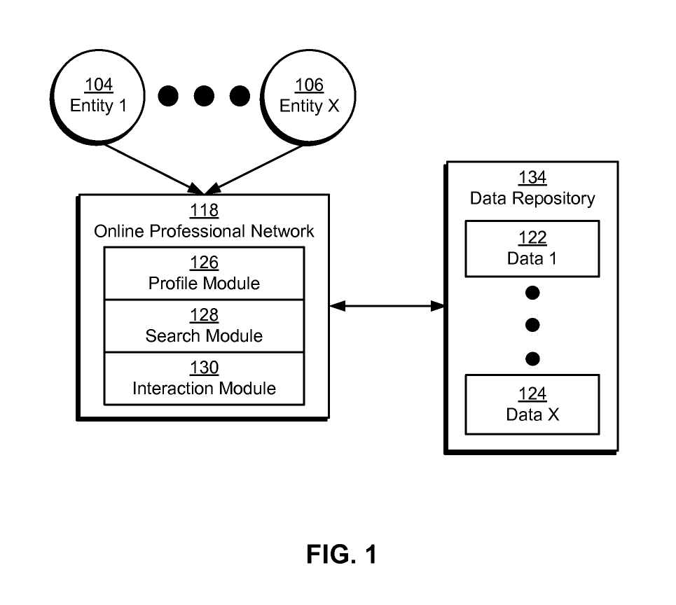

The disclosed embodiments provide a method and system for facilitating interaction within a social network. As shown in FIG. 1, the social network may include an online professional network 118 that is used by a set of entities (e.g., entity 1 104, entity x 106) to interact with one another in a professional and/or business context.

For example, the entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

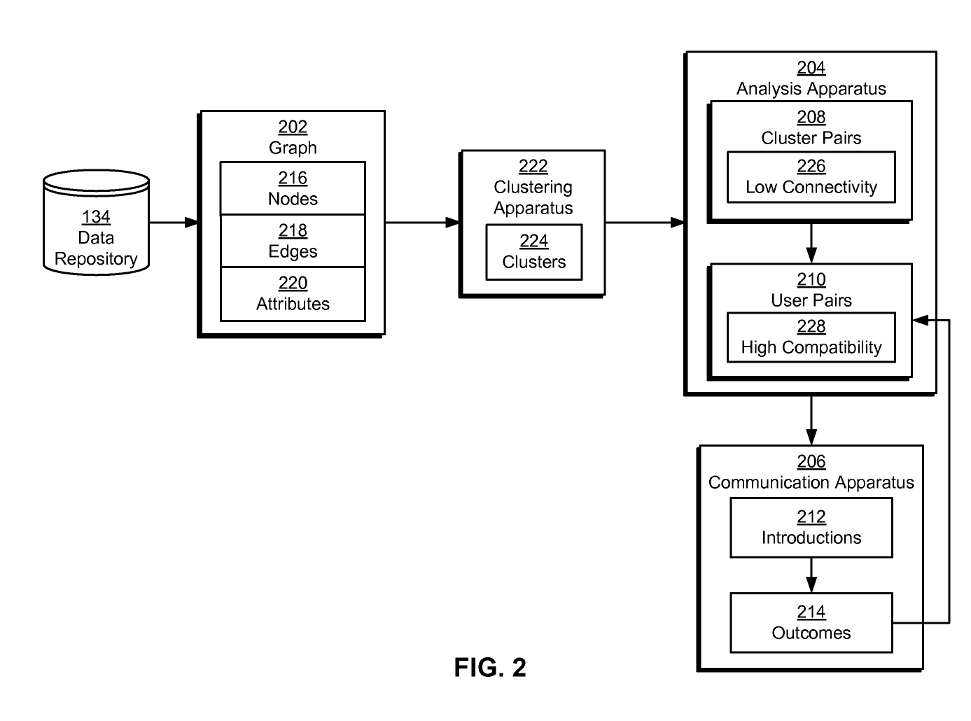

As shown in FIG. 2, data in data repository 134 may be used to form a graph 202 representing entities and the entities' relationships and/or activities in a social network such as online professional network 118 of FIG. 1. Alternatively, graph 202 may be formed from other data, such as proximity data from users connected to cellular towers and/or Wi-Fi access points and/or publicly accessible records of the entities. Graph 202 may include a set of nodes 216, a set of edges 218, and a set of attributes 220.

Nodes 216 in graph 202 may represent entities in the online professional network. For example, the entities represented by nodes 216 may include individual members (e.g., users) of the online professional network, groups joined by the members, and/or organizations such as schools and companies. Nodes 216 may also represent other objects and/or data in the online professional network, such as industries, locations, posts, articles, multimedia, job listings, ads, and/or messages.

Edges 218 may represent relationships and/or interaction between pairs of nodes 216 in graph 202. For example, edges 218 may be directed and/or undirected edges that specify connections between pairs of members, education of members at schools, employment of members at companies, following of a member or company by another member, business relationships and/or partnerships between organizations, and/or residence of members at locations. Edges 218 may also indicate actions taken by entities, such as creating or sharing articles or posts, sending messages, connection requests, joining groups, and/or following other entities.

Nodes 216 and/or edges 218 may also contain attributes 220 that describe the corresponding entities, objects, associations, and/or relationships in the online professional network. For example, a node representing a member may include attributes 220 such as name, username, industry, title, seniority, password, and/or email address. Similarly, an edge representing a connection between the member and another member may have attributes 220 such as a time at which the connection was made, the type of connection (e.g., friend, colleague, classmate, employee, following, etc.), and/or a strength of the connection (e.g., how well the members know one another).

A clustering apparatus 222 may use graph 202 to calculate a set of clusters 224 of users in the social network. To calculate clusters 224, clustering apparatus 222 may use a community-detection technique such as modularity maximization technique, hierarchical clustering, label propagation, and/or Louvain fast modularity. Each cluster may thus represent a set of relatively densely connected nodes within graph 202, while nodes from different clusters may be less inter-connected than nodes within each cluster. In turn, users within a given cluster may generally have limited interaction with users from other clusters. For example, employees of a company may be clustered into distinct organizations or functional units, such as engineering, sales, marketing, legal, analytics, and/or product divisions. Clusters 224 may additionally or instead be formed based on location or some other characteristic. For example, sales employees in the company may be more connected to other sales employees in the same country or continent, and less connected to sales employees in different countries or continents.

Such clustering of users may restrict information exchange within the social network, thus preventing the full utilization of social capital within the social network. Continuing with the above example, employees that interact within their organization and/or with a limited number of other organizations may lack exposure to the perspective or knowledge of employees from other parts of the company. Such lack of interaction across organizations may limit the ability of the employees to innovate, make informed decisions, and/or otherwise perform tasks related to the functioning of the company.

In one or more embodiments, the system of FIG. 2 includes functionality to improve interaction between users in disparate clusters of the social network. First, an analysis apparatus 204 may identify one or more cluster pairs 208 in the set of clusters 224 with low connectivity 226. To identify low connectivity 226 between cluster pairs 208, analysis apparatus 204 may calculate a set of edge weights between pairs of the clusters. For example, each edge weight may be calculated as the ratio of the number of edges between two clusters and the number of edges within one or both clusters. Low edge weights may thus indicate low connectivity 226 between the corresponding cluster pairs 208.

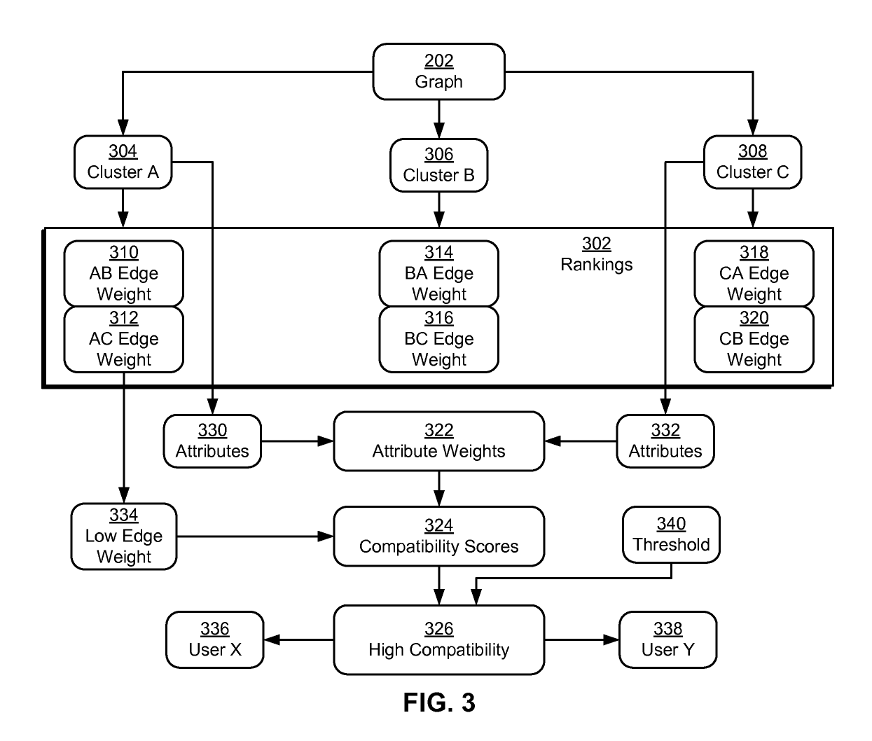

Next, for each cluster pair with low connectivity 226, analysis apparatus 204 may identify one or more user pairs 210 with high compatibility 228. Each user pair may include a first user from a first cluster and a second user from a second cluster that has low connectivity 226 with the first cluster. To identify high compatibility 228 between the two users, analysis apparatus 204 may use attributes 220 of the users to calculate a compatibility score between the users. For example, analysis apparatus 204 may calculate the compatibility score as a measure of the similarity of one or more attributes 220 between the users. If the compatibility score is higher than a threshold and/or compatibility scores between other pairs of users from the first and second clusters, high compatibility 228 may be found. Identification of low connectivity 226 between cluster pairs 208 and high compatibility 228 between user pairs 210 is described in further detail below with respect to FIG. 3.

A communication apparatus 206 may then generate introductions 212 among user pairs 210 with high compatibility 228 to increase interaction between cluster pairs 208 with low connectivity 208. Each introduction may be performed by transmitting the introduction to the corresponding pair of users. For example, communication apparatus 206 may use email, a messaging service, a “People You May Know” feature, and/or an introduction feature on the social network to communicate the introduction to one or both users. Alternatively, the introduction may be made by scheduling an event to be attended by the first and second users. For example, communication apparatus 206 may access calendars of both users and schedule a lunch or coffee meeting at a time when both users are available. Communication apparatus 206 may also, or instead, make the introduction through a third user connected to the first and second users in the social network. For example, communication apparatus 206 may use a messaging service and/or introduction feature in the social network to suggest that the third user introduce the first and second users. After receiving the suggestion to introduce the other two users, the third user may make the introduction through the messaging service and/or introduction feature, thus establishing initial contact between the first and second users and facilitating subsequent communication and interaction between the first and second users.

After introductions 212 are made, communication apparatus 206 may track outcomes 214 of introductions 212. Each outcome may represent a successful or unsuccessful introduction of a pair of users. For example, communication apparatus 206 may identify a successful outcome of an introduction as subsequent communication between the users after the introduction is made, acknowledgment of the introduction, attendance by both users of an event scheduled for introducing the users, and/or connection of the users in the social network. An unsuccessful outcome of the introduction may be identified as a lack of communication, response to the introduction, connection, and/or attendance of the event from one or both users.

Communication apparatus 206 may further identify outcomes 214 by communicating with users to whom introductions 212 were made. For example, communication apparatus 206 may follow up with each pair of introduced users to obtain a rating, score, and/or other measure of the quality of the introduction and/or subsequent interaction between the users. The users may also provide qualitative feedback related to the introduction to communication apparatus 206, such as comments related to the usefulness or relevance of the introduction.

Outcomes 214 may then be used to update the calculation of compatibility between user pairs 210. For example, a statistical model such as a logistic regression model, decision tree, artificial neural network, Bayesian network, and/or support vector machine may be used to calculate compatibility scores and identify user pairs 210 with high compatibility 228. Outcomes 214 of introductions of user pairs 210 may be provided as training data to the statistical model, and analysis apparatus 204 may use the training data to update a set of weights used by the statistical model to calculate compatibility between user pairs 210. Consequently, the system of FIG. 2 may improve the quality or relevance of introductions 212 between pairs of users over time.

Those skilled in the art will appreciate that the system of FIG. 2 may be implemented in a variety of ways. First, analysis apparatus 204, communication apparatus 206, clustering apparatus 222, and/or data repository 134 may be provided by a single physical machine, multiple computer systems, one or more virtual machines, a grid, one or more databases, one or more filesystems, and/or a cloud computing system. Analysis apparatus 204, communication apparatus 206, and clustering apparatus 222 may additionally be implemented together and/or separately by one or more hardware and/or software components and/or layers.

Second, analysis apparatus 204 may use a number of techniques to identify low connectivity 226 in cluster pairs 208 and/or high compatibility 228 in user pairs 210. As mentioned above, analysis apparatus 204 may use various statistical models and/or supervised-learning techniques to update the calculation of compatibility between user pairs 210. Analysis apparatus 204 may also determine connectivity between cluster pairs 208 as edge weights of directed or undirected edges in cluster pairs 208. Analysis apparatus 204 may further tailor the calculation of compatibility scores to different types of users, such as users associated with specific companies, industries, groups, levels of seniority, demographics, and/or locations. For example, analysis apparatus 204 may train different statistical models to produce compatibility scores for different sets of users in the social network. Alternatively, analysis apparatus 204 may train the same statistical model to identify compatibility across multiple companies, industries, groups, demographics, locations, and/or types of users.

FIG. 3 shows the exemplary identification of a high compatibility 326 between a pair of users from a pair of clusters with low connectivity in a social network in accordance with the disclosed embodiments. As shown in FIG. 3, three clusters may be formed from graph 202: cluster A 304, cluster B 306, and cluster C 308. Graph 202 may include nodes (e.g., nodes 216 of FIG. 2) representing some or all of the users in the social network, as well as edges (e.g., edges 218 of FIG. 2) representing relationships between users represented by pairs of the nodes. The clusters may be formed from graph 202 using a community-detection technique and/or other graph-clustering technique.

Next, a set of edge weights between pairs of the clusters is calculated. The edge weights may be calculated for directed edges between cluster pairs. As a result, the edge weights may include an AB edge weight 310 from cluster A 304 to cluster B 306, an AC edge weight 312 from cluster A 304 to cluster C 308, a BA edge weight 314 from cluster B 306 to cluster A 304, a BC edge weight 316 from cluster B 306 to cluster C 308, a CA edge weight 318 from cluster C 308 to cluster A 304, and a CB edge weight 320 from cluster C 308 to cluster B 306. Each edge weight may be calculated by dividing the number of edges between a pair of clusters by the number of edges among nodes in a cluster from which the directed edge originates. For example, if nodes between clusters A 304 and B 306 are connected by 200 edges and nodes within cluster A 304 are connected by 800 edges, AB edge weight 310 may be calculated as 200/800, or 0.25.

Those skilled in the art will appreciate that edge weights between clusters may be calculated in other ways. For example, an edge weight may be calculated for each undirected edge between two clusters by dividing the number of edges between the clusters by the total number of edges among nodes in both clusters. In another example, an edge weight between two clusters may be calculated based on the modularity of one or both clusters.

Rankings 302 of edge weights from each cluster to other clusters may then be generated. For example, edge weights from cluster A 304 to clusters B 306 and C 308 (e.g., AB edge weight 310, AC edge weight 312) may be placed into one ranking. Edge weights from cluster B 306 to clusters A 304 and C 308 (e.g., BA edge weight 314, BC edge weight 316) may be placed into a second ranking. Edge weights from cluster C 308 to clusters A 304 and B 306 (e.g., CA edge weight 318, CB edge weight 320) may be placed into a third ranking.

Each ranking may include, in descending order, edge weights from a given cluster to other clusters in graph 202. As a result, an edge weight at or near the bottom of a given ranking (e.g., a low edge weight) may indicate a low connectivity between the cluster and another cluster associated with the edge weight. For example, rankings 302 may indicate that AC edge weight 312 is a low edge weight 334 from cluster A 304 to cluster C 308.

In turn, the low connectivity between clusters A 304 and C 308 may be improved by introducing and/or connecting pairs of users in clusters A 304 and C 308. As mentioned above, such introductions may be made for pairs of users with high compatibility 326. To determine high compatibility 326 between a pair of users from clusters A 304 and C 308, respectively, attributes 330-332 of users in each cluster may be obtained. Attributes 330-332 may be obtained from graph 202 and/or another repository of user data. Next, a set of attribute weights 322 may be applied to attributes 330-332 of each user from cluster A 304 and each user from cluster C 308 to calculate a set of compatibility scores 324 for all pairs of users between clusters A 304 and C 308. For example, if clusters A 304 and C 308 each have 50 users, 2,500 compatibility scores 324 may be calculated for all pairs of users that span both clusters.

Each user of an online professional network may have attributes 330-332 such as a reputation score (e.g., a measure of a user's reputation in the online professional network), a skill (e.g., a job-related skill), an interest (e.g., hobby, activity, etc.), a group (e.g., club, professional organization, school organization, etc.), a company (e.g., place of employment), an industry, a location, a position, a seniority, and/or others. The user's attributes may be used to populate a user vector for the user. For example, the user vector may include a set of skills possessed by the user, one or more employers of the user, one or more schools attended by the user, the user's location, the user's industry, and the user's reputation score.

To calculate a compatibility score for a pair of users (e.g., from two clusters with low connectivity), user vectors for the users may be combined into a compatibility vector representing the similarity of the users to one another. Continuing with the above example, the compatibility vector may include the geographic distance between the users, a Boolean value for attendance of the same school, a number of common skills, a number of common employers, an overlap in industries, a difference in the users' levels of seniority, and a difference in the users' reputation scores. A set of attribute weights 322 may then be applied to elements of the compatibility vector to obtain a compatibility score for the pair of users. For example, attribute weights 322 may be used to produce the compatibility score as a weighted combination of elements in the compatibility vector. Each attribute weight may represent the relative importance of the corresponding attribute in the compatibility vector. A higher attribute weight may thus increase the contribution of the attribute to the compatibility score, while a lower attribute weight may decrease the contribution of the attribute the compatibility score.

As with the edge weights, compatibility scores 324 may be calculated in a number of ways. For example, compatibility scores 324 may be calculated as linear combinations of attributes 330-332 of pairs of users and attribute weights 322. Other measures of vector similarity, such as cosine similarity or Jaccard similarity, may also be used to compute compatibility scores 324 from pairs of user vectors. Conversely, one or more components of the compatibility score may be based on complementary attributes 330-332 instead of similar attributes 330-332. For example, non-identical but complementary skills such as engineering and technical sales or graphic design and marketing may increase the compatibility score of a pair of users, in lieu of or in addition to identical skills of the users.

A threshold 340 may then be applied to compatibility scores 324 to identify high compatibility 326 between a pair of users X 336 and Y 338. For example, threshold 340 may be set as a numeric threshold for compatibility scores 324 and/or a percentile of the top compatibility scores in the set of compatibility scores 324 (e.g., top 5% of compatibility scores 324 between pairs of users spanning two clusters). As a result, high compatibility 326 of a pair of users may be found if the compatibility score for the pair exceeds the threshold. Alternatively, the compatibility score may be calculated as the absolute value of the difference in the users' reputation scores or levels of seniority, and threshold 340 may be set to a maximum difference in reputation score or level of seniority. Thus, a pair of users with a compatibility score that falls below threshold 340 may be identified as having high compatibility because the users have similar levels of responsibility or career experience.

Once high compatibility 326 is identified in a pair of users X 336 and Y 338, the users may be introduced to facilitate interaction between two clusters A 304 and C 308 with low connectivity (e.g., low edge weight 334). For example, an introduction of the two users may be made through a message, a scheduled event, and/or a third user who is connected to both users in the social network. An outcome of the introduction may then be obtained and used to update the calculation of compatibility scores 324.

For example, the outcome may be obtained as a binary measure of the success or lack of success of the introduction. A successful introduction may be represented by subsequent communication between the users, acceptance of the introduction by both users, and/or connection of the users in the social network. An unsuccessful introduction may be represented by a lack of communication between the users, a lack of response by one or both users to the introduction, and/or a lack of connection of the users in the social network.

The outcome may also include a numeric rating or score from one or both users of the relevance or usefulness of the introduction, in lieu of or in addition to the binary measure of success or lack of success. The outcome may then be provided as training data to a logistic regression model, support vector machine, decision tree, artificial neural network, Bayesian network, and/or other statistical model, and a supervised-learning technique may be used to update attribute weights 322 within the statistical model. The relevance or effectiveness of introductions of pairs of users in the social network may thus improve as attribute weights 322 are updated and more accurate compatibility scores 324 are calculated using the statistical model.

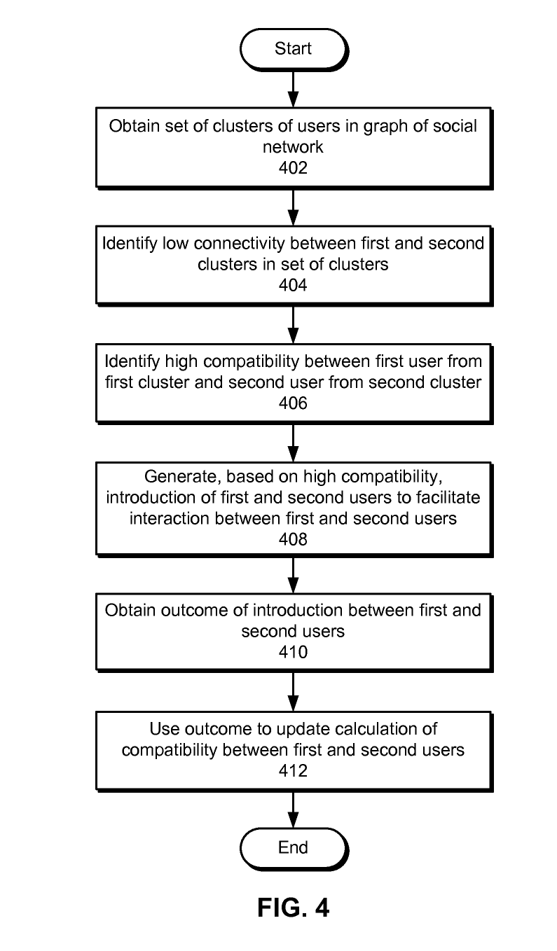

FIG. 4 shows a flowchart illustrating the process of facilitating interaction within a social network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

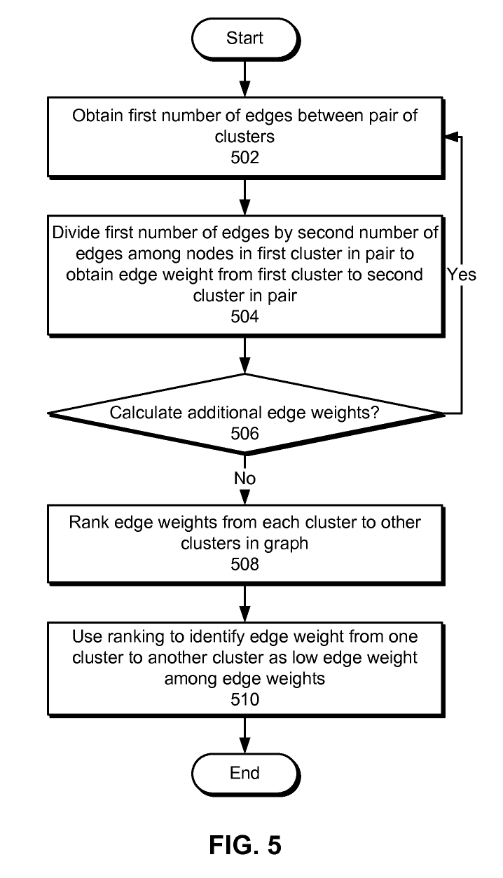

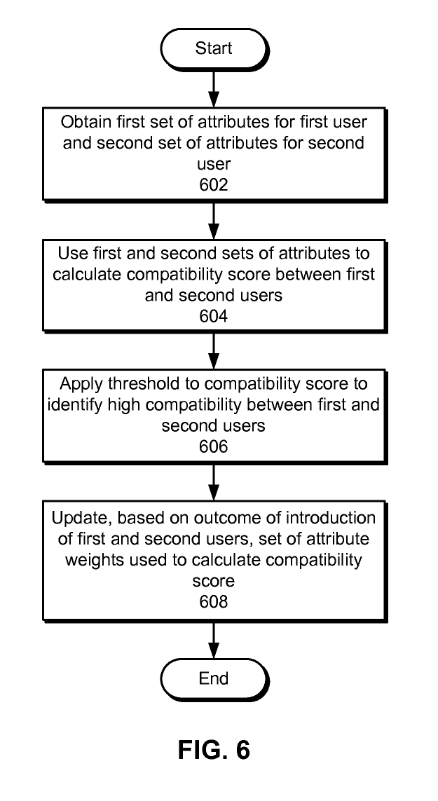

First, a set of clusters of users in a graph of a social network is obtained (operation 402). The clusters may be calculated from the graph using a community-detection technique such as a modularity maximization, hierarchical clustering, label propagation, and/or Louvain fast modularity. Next, a low connectivity between a first cluster and a second cluster in the set of clusters is identified (operation 404), as described in further detail below with respect to FIG. 5. A high compatibility between a first user from the first cluster and a second user from the second cluster is then identified (operation 406), as described in further detail below with respect to FIG. 6.

An introduction of the first and second users is generated based on the high compatibility to facilitate interaction between the first and second users (operation 408). For example, a message containing the introduction may be transmitted to both users, an event to be attended by both users may be scheduled, and/or the introduction may be made through a third user connected to the first and second users. The introduction may also be generated based on the user preferences of one or both users. For example, one or both users may select their preferred methods of being introduced to other users in the social network, and the introduction may be made using some or all of the preferred methods.

Finally, an outcome of the introduction may be obtained (operation 410) and used to update a calculation of compatibility between the first and second users (operation 412). For example, the outcome may be obtained as a binary metric representing the success or lack of success of the introduction and/or as a numeric score or rating of the usefulness or relevance of the introduction from one or both users. The outcome may then be provided as training data to a statistical model, and calculation of the compatibility by the statistical model may be updated based on the outcome.

FIG. 5 shows a flowchart illustrating the process of identifying low connectivity between a first cluster and a second cluster in a social network in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

The low connectivity may be identified by calculating a set of edge weights between pairs of clusters in the social network. First, a first number of edges between a pair of clusters is obtained (operation 502) and divided by a second number of edges among nodes in a first cluster in the pair to obtain an edge weight from the first cluster to a second cluster in the pair (operation 504). Additional edge weights may also be calculated (operation 506) for other pairs of clusters in the social network. If additional edge weights are to be calculated, each edge weight may be calculated for a directed edge between each pair of clusters by dividing the number of edges between the pair of clusters by the number of edges among nodes in the cluster from which the directed edge originates (operations 502-504).

After all edge weights have been calculated, the edge weights from each cluster to other clusters in the graph are ranked (operation 508). For example, edge weights from one cluster to all other clusters in the graph may be ranked in descending order. The ranking may then be used to identify an edge weight from one cluster to another cluster as a low edge weight among the edge weights (operation 510). For example, the low edge weight may be obtained from the bottom of the ranking and used as an indicator of low connectivity between the two clusters. After the low connectivity is identified, pairs of users across the clusters with high compatibility may be identified, as described in further detail below with respect to FIG. 6.

FIG. 6 shows a flowchart illustrating the process of identifying high compatibility between a pair of users in a pair of clusters with low connectivity in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a first set of attributes for a first user and a second set of attributes for a second user are obtained (operation 602). Illustratively, the attributes may include a reputation score, a skill, an interest, a group, a company, an industry, a location, a position, and/or a seniority. Next, the first and second sets of attributes are used to calculate a compatibility score between the first and second users (operation 604). For example, the first and second sets of attributes may be used to populate a compatibility vector, and a set of attribute weights may be used to produce the compatibility score as a weighted combination of the elements of the compatibility vector.

A threshold is then applied to the compatibility score to identify a high compatibility between the first and second users (operation 606). For example, the threshold may represent a minimum compatibility score that indicates high compatibility between two users. On the other hand, the threshold may represent a maximum difference in reputation scores or seniority between the two users. As a result, a compatibility score that is calculated as the difference in the users' reputation scores or seniority may be indicative of high compatibility if the compatibility score falls below the threshold.

Finally, a set of attribute weights used to calculate the compatibility score is updated based on the outcome of an introduction of the first and second users (operation 608). For example, the outcome may be used to update a statistical model that uses the attribute weights to calculate the compatibility score.

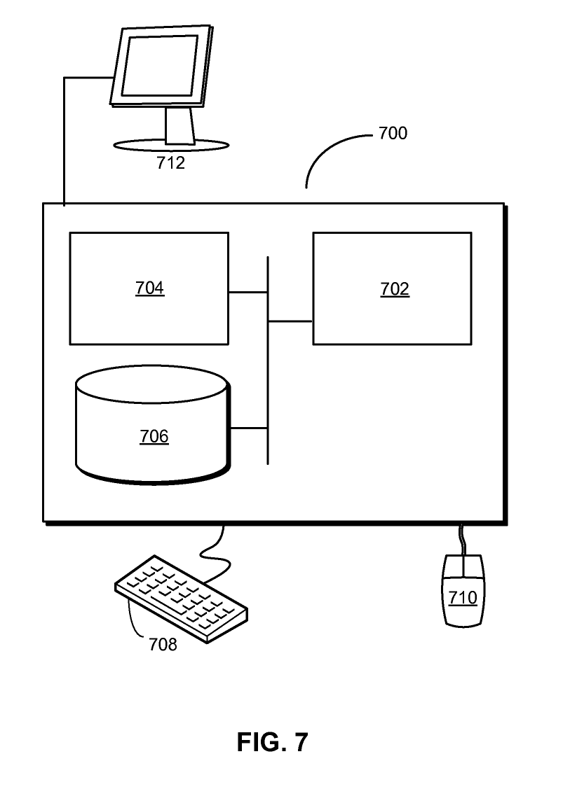

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for increasing interaction within a social network. The system may include a clustering apparatus that calculates a set of clusters of users in a graph of a social network. The system may also include an analysis apparatus that identifies a low connectivity between a first cluster and second cluster in the set of clusters and a high compatibility between a first user from the first cluster and a second user from the second cluster. The system may further include a communication apparatus that generates, based on the high compatibility, an introduction of the first and second users to facilitate interaction between the first and second users.

In addition, one or more components of computer system 700 may be remotely located and connected to the other components over a network. Portions of the present embodiments (e.g., analysis apparatus, communication apparatus, clustering apparatus, etc.) may also be located on different nodes of a distributed system that implements the embodiments. For example, the present embodiments may be implemented using a cloud computing system that increases interaction among a set of remote users by introducing pairs of the users with high compatibility from clusters of the users with low connectivity.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of clusters of users in a graph of a social network, wherein the graph comprises:
a set of nodes representing the users; and
a set of edges representing relationships between pairs of the users;
identifying, by one or more computer systems:
a low connectivity between a first cluster and second cluster in the set of clusters; and
a high compatibility between a first user from the first cluster and a second user from the second cluster; and
generating, based on the high compatibility, an introduction of the first and second users to facilitate interaction between the first and second users.

2. The method of claim 1, wherein identifying the low connectivity between the first and second clusters comprises:
calculating a set of edge weights between pairs of the clusters; and
identifying the first and second clusters with a low edge weight among the set of edge weights.

3. The method of claim 2, wherein calculating the set of edge weights between pairs of the clusters comprises:
obtaining a first number of edges between the first and second clusters; and
dividing the first number of edges by a second number of edges among nodes in the first cluster to obtain an edge weight from the first cluster to the second cluster.

4. The method of claim 3, wherein identifying the first and second clusters with the low edge weight comprises:
ranking a subset of the edge weights from the first cluster to other clusters in the graph; and
using the ranking to identify the edge weight from the first cluster to the second cluster as the low edge weight among the subset of the edge weights.

5. The method of claim 1, further comprising:
obtaining an outcome of the introduction between the first and second users; and
using the outcome to update a calculation of a compatibility between the first and second users.

6. The method of claim 5, wherein identifying the high compatibility between the first and second users comprises:
obtaining a first set of attributes for the first user and a second set of attributes for the second user;
using the first and second sets of attributes to calculate a compatibility score between the first and second users; and
applying a threshold to the compatibility score to identify the high compatibility between the first and second users.

7. The method of claim 6, wherein using the outcome to update the calculation of the compatibility between the first and second users comprises:
updating, based on the outcome, a set of attribute weights used to calculate the compatibility score from the first and second sets of attributes.

8. The method of claim 6, wherein the first and second sets of attributes comprise at least one of:
a reputation score;
a skill;
an interest;
a group;
a company;
an industry;
a location;
a position; and
a seniority.

9. The method of claim 1, wherein obtaining the set of clusters of users in the graph of the social network comprises:
using the graph to calculate, by the one or more computer systems, the set of clusters of the users.

10. The method of claim 9, wherein the set of clusters is calculated using a community-detection technique.

11. The method of claim 1, wherein generating the introduction of the first and second users comprises at least one of:
transmitting a message containing the introduction to the first and second users;
scheduling an event to be attended by the first and second users; and
generating the introduction through a third user connected to the first and second users.

12. The method of claim 1,
wherein the set of users includes a set of companies, and
wherein the set of edges represent at least one of:
an employment of a user at a company;
a connection of the user to another user; and
a following of the user or the company by the other user.

13. An apparatus, comprising:
one or more processors; and
memory storing instructions that, when executed by the one or more processors, cause the apparatus to:
obtain a set of clusters of users in a graph of a social network, wherein the graph comprises:
a set of nodes representing the users; and
a set of edges representing relationships between pairs of the users;
identify a low connectivity between a first cluster and second cluster in the set of clusters; and
identify a high compatibility between a first user from the first cluster and a second user from the second cluster; and
generate, based on the high compatibility, an introduction of the first and second users to facilitate interaction between the first and second users.

14. The apparatus of claim 13, wherein identifying the low connectivity between the first and second clusters comprises:
calculating a set of edge weights between pairs of the clusters; and
identifying the first and second clusters with a low edge weight among the set of edge weights.

15. The apparatus of claim 13, wherein the memory further stores instructions that, when executed by the one or more processors, cause the apparatus to:
obtain an outcome of the introduction between the first and second users; and
use the outcome to update a calculation of a compatibility between the first and second users.

16. The apparatus of claim 15, wherein identifying the high compatibility between the first and second users comprises:
obtaining a first set of attributes for the first user and a second set of attributes for the second user;
using the first and second sets of attributes to calculate a compatibility score between the first and second users; and
applying a threshold to the compatibility score to identify the high compatibility between the first and second users.

17. The apparatus of claim 16, wherein using the outcome to update the calculation of the compatibility between the first and second users comprises:
updating, based on the outcome, a set of attribute weights used to calculate the compatibility score from the first and second sets of attributes.

18. The apparatus of claim 13, wherein generating the introduction of the first and second users comprises at least one of:
transmitting a message containing the introduction to the first and second users;
scheduling an event to be attended by the first and second users;
generating the introduction through a third user connected to the first and second users.

19. A system, comprising:
an analysis non-transitory computer readable medium comprising instructions that, when executed by one or more processors, cause the system to:
obtain a set of clusters of users in a graph of a social network, wherein the graph comprises:
a set of nodes representing the users; and
a set of edges representing relationships between pairs of the users;
identify a low connectivity between a first cluster and second cluster in the set of clusters; and
identify a high compatibility between a first user from the first cluster and a second user from the second cluster; and
a communication non-transitory computer readable medium comprising instructions that, when executed by the one or more processors, cause the system to generate, based on the high compatibility, an introduction of the first and second users to facilitate interaction between the first and second users.

20. The system of claim 19, wherein the analysis non-transitory computer readable medium further comprises instructions that, when executed by the one or more processors, cause the system to:
obtain an outcome of the introduction between the first and second users; and
use the outcome to update a calculation of a compatibility between the first and second users.
